(19) United States
(12) Patent Application Publication
(10) Pub. No.: US 2026/0023773 A1
(43) Pub. Date: Jan. 22, 2026

(54) DETECTION OF OUT-OF-DISTRIBUTION VISUAL DATA VIA TEXT-BASED TRAINING

(71) Applicant: QUALCOMM Incorporated, San Diego, CA (US)

(72) Inventors: Yongho SHIN, Seoul (KR); Saehyung LEE, Seoul (KR)

(21) Appl. No.: 18/775,606

(22) Filed: Jul. 17, 2024

(51) Int. Cl. G06F 16/35

(52) U.S. Cl. CPC G06F 16/35

(57) ABSTRACT

Certain aspects of the present disclosure provide techniques for detecting out-of-distribution data. Such techniques may include: processing an input data sample using a trained model to generate an input data embedding; obtaining a set of in-distribution (ID) text embeddings; obtaining a set of trained OOD embeddings; classifying the input data sample as OOD data or ID data based on the input data embedding, the set of ID text embeddings, and the set of trained OOD embeddings; and outputting an indication of whether the input data is classified as OOD data or ID data based on the classification.

### INTRODUCTION

### Field of the Disclosure

The present disclosure relates to the field of machine learning and, more particularly, to systems and methods for detecting out-of-distribution (OOD) data.

### DESCRIPTION OF RELATED ART

Machine learning models can be used in various applications to make predictions or decisions based on input data. These models can be trained on a specific set of in-distribution (ID) data that is representative of the expected inputs during deployment. However, when the models encounter input data that may differ (usually significantly) from the training data, known as out-of-distribution (OOD) data, the performance of the model can degrade, leading to incorrect predictions or decisions.

Detecting OOD data is important for ensuring the reliability and robustness of machine learning systems. Traditional approaches for OOD detection may rely on the availability of labeled OOD data during training. However, obtaining such labeled OOD data can be challenging and time-consuming, as it can require manually identifying and annotating samples that are dissimilar to the ID data.

To address this challenge, some methods have been proposed that leverage unlabeled data for OOD detection. These methods may involve training a machine learning model to distinguish between ID and OOD samples based on certain statistical properties or by using techniques such as outlier exposure. However, these approaches still require access to a representative set of OOD data during training, which may not always be feasible.

Another limitation of some OOD detection methods is their reliance on visual data. In many real-world scenarios, the entire visual data distribution may not be known or accessible during training. This can limit the effectiveness of these methods in detecting OOD samples that fall outside the known visual data distribution. Therefore, there is a need for an efficient and effective method for detecting OOD data that does not rely on labeled OOD samples or access to the entire visual data distribution during training. Such techniques could enable the development of more robust and reliable machine learning systems that can handle a wide range of input data.

### SUMMARY

One aspect provides a method for detecting out-of-distribution (OOD) data. In certain aspects, the method may include: processing an input data sample using a trained model to generate an input data embedding; obtaining a set of in-distribution (ID) text embeddings; obtaining a set of trained OOD embeddings; classifying the input data sample as OOD data or ID data based on the input data embedding, the set of ID text embeddings, and the set of trained OOD embeddings; and outputting an indication of whether the input data is classified as OOD data or ID data based on the classification.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts a system for detecting out-of-distribution data in accordance with examples of the present disclosure.

FIG. 2 depicts an example process for generating in-distribution embeddings, in accordance with examples of the present disclosure.

FIG. 3 depicts an example process for generating out-of-distribution embeddings, in accordance with examples of the present disclosure.

FIG. 4A depicts an example process for training an out-of-distribution detector, in accordance with examples of the present disclosure.

FIG. 4B depicts additional details of an example process for training the out-of-distribution detector, in accordance with examples of the present disclosure.

FIG. 5 depicts an example process for detecting out-of-distribution data using a trained detector, in accordance with examples of the present disclosure.

FIG. 6 illustrates an example artificial intelligence (AI) architecture, in accordance with examples of the present disclosure.

FIG. 7 illustrates an example AI architecture of a first device that is in communication with a second device.

FIG. 8 illustrates an example artificial neural network, in accordance with examples of the present disclosure.

FIG. 9 depicts a method for detecting out-of-distribution data, out-of-distribution detector, in accordance with examples of the present disclosure.

FIG. 10 depicts aspects of an example processing system that can be used to implement the methods and systems described in this disclosure.

### DETAILED DESCRIPTION

Aspects of the present disclosure provide apparatuses, methods, processing systems, and computer-readable mediums for detecting out-of-distribution data.

In the field of machine learning, it is important for machine learning models to accurately identify data that is different from what they were trained on. This type of data is called out-of-distribution (OOD) data. Existing methods for detecting OOD data often require a lot of labeled examples of OOD data during training, which can be difficult and expensive to obtain. Additionally, these methods may not work well when presented with new types of OOD data that they have not seen before.

Examples of the present disclosure describe techniques for detecting OOD data that addresses the challenges describe above. In some examples, a machine learning model can be trained to learn representations, called embeddings, which capture various characteristics of OOD data while being different from the representations of normal data (e.g., in-distribution data). In some aspects, this can be accomplished through a machine learning model training process that uses a set of words and/or sentence templates to generate examples of in-distribution text and out-of-distribution text. These examples can then be used to obtain in-distribution embeddings and out-of-distribution embeddings, which can serve as reference points for training the machine learning model. In some aspects, the training process can be guided by a loss function that encourages the machine learning model to learn embeddings that are different from the in-distribution embeddings while capturing the characteristics of the out-of-distribution data. The resulting trained embeddings can be used by a classifier to effectively detect OOD data during inference.

The techniques described above offer several technical benefits over existing methods. First, such techniques may not require a large amount of labeled OOD data during training, making such techniques viable even when large amounts of labeled OOD data are not available. Secondly, such techniques may work well with new types of OOD data that the machine learning model has not been exposed to before, thereby providing the technical effect of more accurately identifying a larger set of OOD data, which may enhance the model's applicability in real-world scenarios. Further, in some aspects, the described techniques can use an existing trained model that has been trained on image and text relationships; in some aspects, such a model can capture rich semantic information and lead to more accurate OOD detection.

In some aspects, the techniques discussed herein for detecting out-of-distribution data in machine learning systems provide a technical solution to the problem of unreliable and inaccurate predictions when models encounter data that significantly differs from their training data. In some aspects, the use of in-distribution embeddings, out-of-distribution embeddings, and trainable embeddings enables tailored detection of out-of-distribution data based on data characteristics and requirements. In examples, this can improve upon existing approaches that rely on large amounts of labeled out-of-distribution data and that have a hard time generalizing to new types of out-of-distribution data. Such techniques therefore advance the field of out-of-distribution detection by enabling automated and accurate identification of out-of-distribution data.

### Example System for Detecting Out-Of-Distribution Data

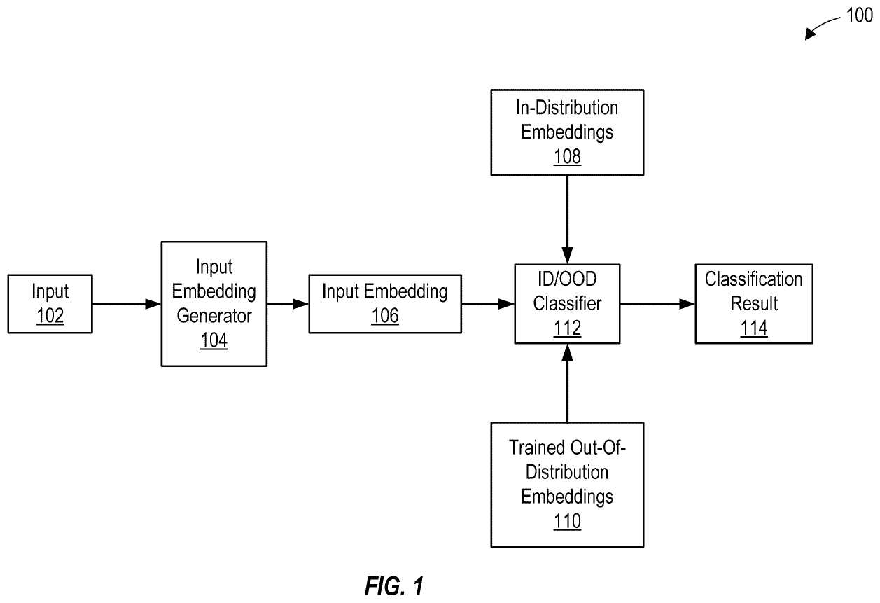

FIG. 1 illustrates a block diagram of an example system 100 for detecting out-of-distribution (OOD) data, in accordance with aspects of the present disclosure. The system 100 may include an input 102, an input embedding generator 104, an input embedding 106, in-distribution embeddings 108, trained out-of-distribution embeddings 110, an in-distribution/out-of-distribution (ID/OOD) classifier 112, and a classification result 114.

In some aspects, the input 102 can represent a data sample to be classified as either in-distribution (ID) or out-of-distribution (OOD). In some aspects, the input 102 can be an image, a video frame, a text document, an audio clip, or any other type of data that can be processed by the system 100. The input 102 may be acquired from one or more various sources, such as image sensors, databases, or user input. For example, the input 102 may be acquired by one or more sensors (e.g., one or more image sensors). For example, the input 102 may include one or more images of one or more of text or video objects. In another example, the one or more sensors may include one or more microphones and the input 102 may comprise audio including speech. In certain aspects, the audio including speech may be converted to text, such as using a speech to text converter, and the input 102 may comprise the text. The input 102 can be preprocessed, if needed, to ensure compatibility with the input embedding generator 104. Preprocessing techniques may include resizing, normalization, or feature extraction, depending on the type and format of the input data. In examples, the input 102 can be provided to the input embedding generator 104 for further processing.

In certain aspects, the input embedding generator 104 can process the input 102 to generate an input embedding 106. In some aspects, the input embedding generator 104 can be a trained model, such as a deep neural network, that learns to map the input data to a lower-dimensional representation in an embedding space. For example, the input embedding generator 104 can be a convolutional neural network (CNN) for processing image data, a recurrent neural network (RNN) or transformer model for processing sequential data such as text or audio, or a graph neural network (GNN) for processing structured data such as graphs or point clouds.

In examples, the input embedding generator 104 can be trained using various techniques, such as unsupervised learning, self-supervised learning, or transfer learning. The choice of the training approach may depend on the availability of labeled data, the complexity of the input data, and the desired performance of the system 100. In some examples, the input embedding generator 104 can be trained on a large dataset and fine-tuned for the specific task of OOD detection. Examples of the input embedding generator 104 include, but are not limited to, ResNet, VGG, or inception models for image data; BERT, GPT, or LSTM models for text data; and PointNet or Graph Convolutional Networks for point cloud or graph data, respectively.

In some aspects, the input embedding 106 can be a dense vector representation of the input 102 in the embedding space. Thus, the input embedding 106 may capture relevant features and characteristics of the input 102 that may distinguish ID samples from OOD samples. The dimensionality of the input embedding 106 can vary depending on the complexity of the input data and the architecture of the input embedding generator 104. In some aspects, the input embedding 106 can be normalized or standardized to provide compatibility with the subsequent components of the system 100. The input embedding 106 can be input to the ID/GOD classifier 112, which uses it along with the in-distribution embeddings 108 and the trained out-of-distribution embeddings 110 to make a classification decision (e.g., ID or OOD).

In some aspects, the in-distribution embeddings 108 represent a set of embeddings (e.g., one or more embeddings) corresponding to in-distribution (ID) data. The in-distribution embeddings 108 can be obtained by processing a set of ID text samples using a trained model, such as the input embedding generator 104 or a separate text encoder. The ID text samples can be generated using prompt templates filled with class names, descriptions related to the ID data, and/or originate from text describing an image in an image-text pair that is provided to a model, such as the input embedding generator 104, during a training process.

In some examples, the in-distribution embeddings 108 can be generated ahead of time and stored for efficient retrieval during a classification process. The number of in-distribution embeddings 108 can vary depending on the number of classes or categories in the ID data. That is, the in-distribution embeddings 108 may act as reference points in the embedding space, representing the expected distribution of ID samples.

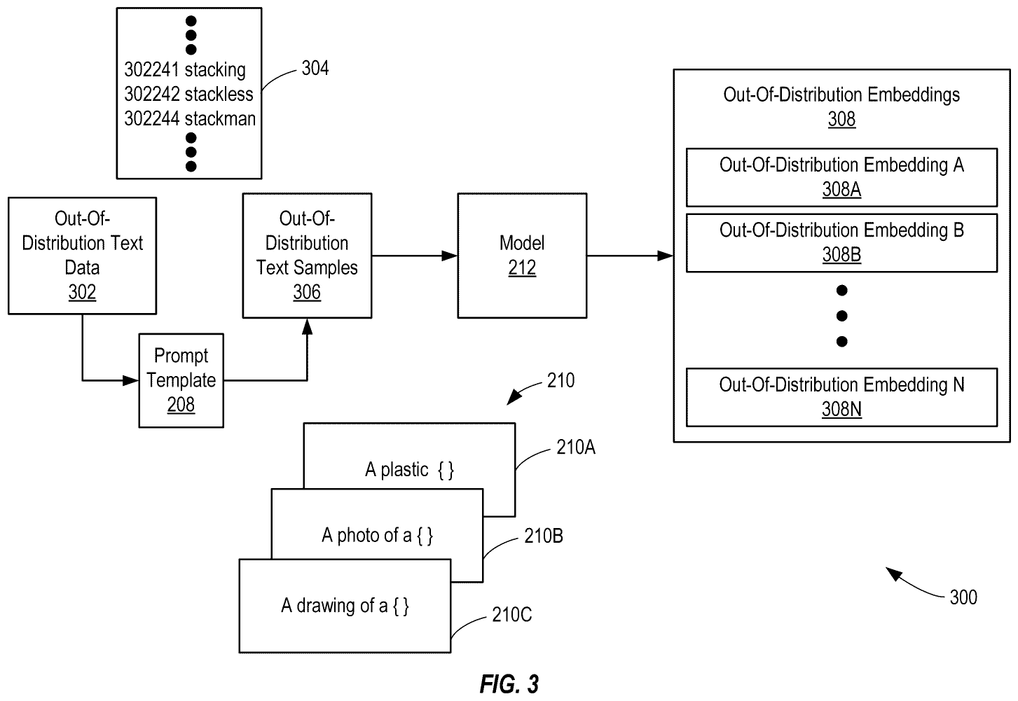

The trained out-of-distribution embeddings 110 represent a set of embeddings corresponding to the out-of-distribution (OOD) data. The trained out-of-distribution embeddings 110 may be obtained by training a set of trainable OOD embeddings using a loss function that encourages the trainable OOD embeddings to be dissimilar from the in-distribution embeddings 108. The training process can involve generating OOD text samples using prompt templates filled with words, such as from a large corpus, such as a real-world English word set, as will be described in FIG. 3. In some aspects, the trained out-of-distribution embeddings 110 can be updated iteratively during a training process to improve their ability to distinguish OOD samples from ID samples. The number of trained out-of-distribution embeddings 110 can be determined based on the desired granularity of OOD detection and an availability of computational resources.

The ID/GOD classifier 112 can receive the input embedding 106, the in-distribution embeddings 108, and the trained out-of-distribution embeddings 110 as inputs and generate a classification result 114 indicating whether the input 102 is an ID sample or an OOD sample. The ID/GOD classifier 112 can be implemented using various techniques, such as by obtaining a ratio of the summation of the dot product of the input embedding 106 and the in-distribution embeddings 108 and the summation of the dot product of the input embedding 106 and the in-distribution embeddings 108 and the dot product of the trained out-of-distribution embeddings 110. Alternatively, or in addition, other techniques may be utilized such as, but not limited to, cosine similarity, dot product, or Euclidean distance, to measure the similarity between the input embedding 106 and the in-distribution embeddings 108 and the trained out-of-distribution embeddings 110.

In some examples, the ID/GOD classifier 112 can compute a set of ID probability scores based on the similarity between the input embedding 106 and each of the in-distribution embeddings 108. Similarly, the ID/GOD classifier 112 can compute a set of OOD probability scores based on the similarity between the input embedding 106 and each of the trained out-of-distribution embeddings 110. These probability scores can be combined, such as through a weighted sum or average, to obtain an overall OOD probability score. The classification result 114 may be the output of the ID/GOD classifier 112, indicating a likelihood of whether the input 102 is classified as an ID sample or an OOD sample. In some aspects, the classification result 114 can be a binary label, with one value representing ID and the other representing OOD. Alternatively, or in addition, the classification result 114 can be a probability score, indicating the likelihood of the input 102 being an OOD sample.

The classification result 114 can be used to make decisions or trigger actions in the system 100 or in downstream processes. For example, if the input 102 is classified as an OOD sample, the system 100 may flag it for further analysis, trigger an alert, or route it to a specialized handling mechanism. As another example, if the input 102 is classified as an ID sample, it may be processed using a standard pipeline or used for its intended purpose.

### Example System for Obtaining In-Distribution Embeddings

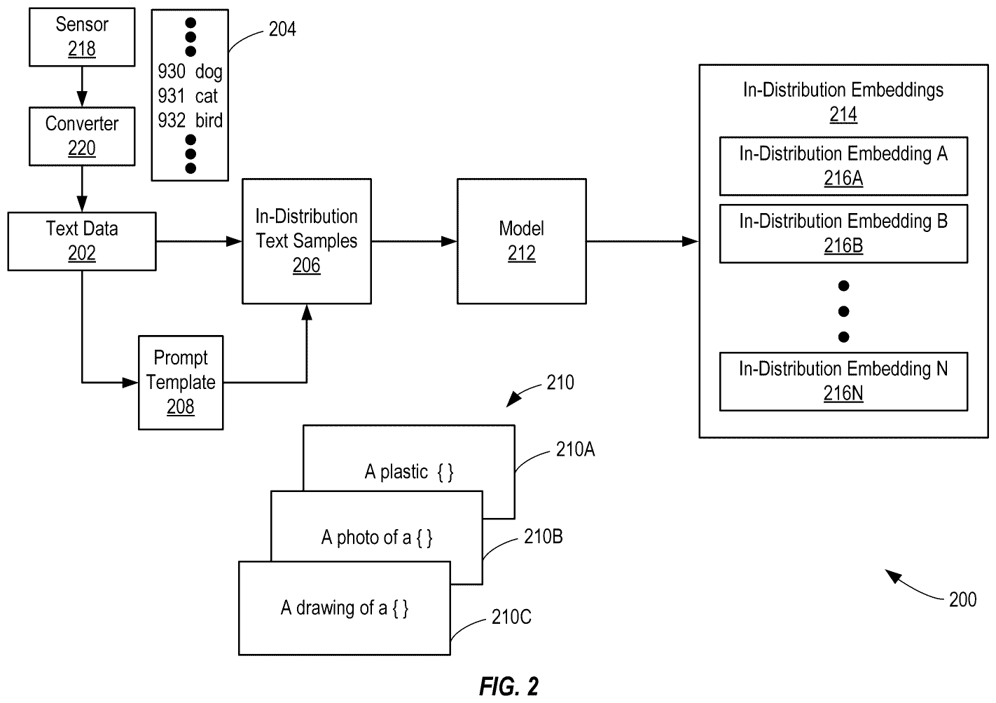

FIG. 2 illustrates a block diagram of an example system 200 for obtaining in-distribution embeddings, in accordance with aspects of the present disclosure. The system 200 can include text data 202, example text data 204, in-distribution text sample(s) 206, prompt template(s) 208, example prompt(s) 210 (e.g., including example prompts 210A, 210B, and 210C), a model 212, and in-distribution embeddings 214 (e.g., including example in-distribution embeddings 216A, 216B, and 216N).

In certain aspects, the text data 202 represents a collection of textual information that is associated with the in-distribution (ID) data. In some aspects, the text data 202 can be obtained from various sources, such as image/text pairs used for training the model 212, annotations or captions associated with ID images, or manually curated text descriptions of ID classes or categories. The text data 202 can be processed to remove noise, inconsistencies, or irrelevant information. Processing techniques may include tokenization, normalization, or filtering based on specific criteria. The text data 202 can serve as a basis for generating in-distribution text samples 206 that are representative of the ID data.

The example text data 204 illustrates a subset of the text data 202, providing illustrative instances of the textual information corresponding to text data 202. In the example shown in FIG. 2, the example text data 204 includes words such as “dog,” “cat,” and “bird,” which may correspond to different classes or categories in the ID data. The example text data 204 can be selected based on various criteria, such as frequency of occurrence, relevance to the ID data, or diversity of content. The example text data 204 can be used to generate specific in-distribution text samples 206 or to provide insights into the nature and composition of the text data 202.

In some examples, the in-distribution text samples 206 can be generated by combining the text data 202 with one or more prompt template(s) 208. In some aspects, the in-distribution text samples 206 can be created by directly using the text data 202 itself, without the need for prompt template(s) 208. However, in other aspects, the prompt template(s) 208 can be employed to provide a structured and consistent format for the in-distribution text samples 206. The prompt template(s) 208 may be patterns or structures that specify how the text data 202 should be combined or arranged to form the in-distribution text samples 206. The prompt template(s) 208 can include placeholders or variables that are filled with specific instances from the text data 202. In some aspects, the use of prompt template(s) 208 allows for the generation of diverse and representative in-distribution text samples 206.

The example prompt(s) 210, including example prompts 210A, 210B, and 210C, illustrate instances of the in-distribution text samples 206 generated using the prompt template(s) 208 and the text data 202. In the example shown in FIG. 2, the example prompts 210A, 210B, and 210C include phrases such as “a photo of a { }”, “a drawing of a { }”, and “a plastic { }”, where the placeholders “{ }” are filled with words from the example text data 204, such as “dog,” “cat,” or “bird.” The example prompts 210 can be generated by randomly sampling or selecting words from the text data 202 and inserting them into the prompt template(s) 208. The number and diversity of example prompt(s) 210 can be adjusted based on a desired granularity and coverage of the in-distribution text samples 206.

In some aspects, the in-distribution data can be multi-modal. For example, the in-distribution data can be obtained from various types of input modalities. As an example, the in-distribution data can include text data 202 obtained from sources such as documents, articles, or speech input, as well as image data, video data, or audio data. In some aspects, the in-distribution data can include speech; when speech input is used, the speech maybe acquired from a sensor 218 and converted using a converter 220 to text data. In some aspects, the sensor 218 may be a microphone and the converter 220 may be a speech-to-text converter. In some aspects, when image or video data is used, optical character recognition (OCR) techniques can be applied to extract text data from the images or video frames, where the sensor 218 may be an image sensor and the converter 220 may be apply one or more OCR techniques. Accordingly, in some aspects, the resulting text data from these various modalities can then be used as in-distribution text data 202 for generating in-distribution text samples 206 and obtaining in-distribution text embeddings 214.

In some aspects, the model 212 may be a trained machine learning model that takes the in-distribution text samples 206 as input and generates corresponding in-distribution embeddings 214. In some aspects, the model 212 can be a pre-trained language model, such as CLIP (Contrastive Language-Image Pre-training), that has been trained on a large corpus of text and image data. The model 212 can process each in-distribution text sample 206 and map it to a dense vector representation in an embedding space. In examples, the resulting in-distribution embeddings 214 can capture the semantic and contextual information present in the in-distribution text samples 206. The dimensionality and structure of the in-distribution embeddings 214 can vary depending on the architecture and training of the model 212.

In some aspects, the in-distribution embeddings 214, including example in-distribution embeddings 216A, 216B, and 216N, may represent the output of the model 212 for the corresponding in-distribution text samples 206. Each in-distribution embedding, such as 216A, 216B, or 216N, can be a dense vector that encodes relevant features and characteristics of the associated in-distribution text sample. The in-distribution embeddings 214 can act as reference points in an embedding space, representing an expected distribution of ID samples. These embeddings can be used by downstream components, such as the ID/OOD classifier 112 in FIG. 1, to make decisions about whether an input data sample is an ID sample or an OOD sample.

In some aspects, the in-distribution embeddings 214 can be stored and reused for efficient classification or comparison purposes. The number and diversity of in-distribution embeddings 214 can be determined based on the complexity of the ID data and the desired performance of the OOD detection system.

### Example System for Obtaining Out-Of-Distribution Embeddings

FIG. 3 illustrates a block diagram of an example system 300 for obtaining out-of-distribution embeddings, in accordance with aspects of the present disclosure. The system 300 can include out-of-distribution text data 302, prompt template(s) 208, out-of-distribution text samples 306, example prompt(s) 210 (e.g., including example prompts 210A, 210B, and 210C), a model 212, and out-of-distribution embeddings 308 (e.g., including example out-of-distribution embeddings 308A, 308B, and 308N).

In certain aspects, the out-of-distribution text data 302 represents a collection of textual information that is distinct from the in-distribution (ID) data. In some aspects, the out-of-distribution text data 302 can be a large list of words, where each word corresponds to a distinct vocabulary word. The out-of-distribution text data 302 can be obtained from various sources, such as public datasets, dictionaries, or web-scraped text corpora. In some examples, the out-of-distribution text data 302 can include a substantial number of words, such as over 100,000 words (e.g., around 370,000 words), to provide a diverse and comprehensive coverage of the language. The exact number of words in the out-of-distribution text data 302 may vary depending on the desired granularity and the available computational resources. Additionally, the out-of-distribution text data 302 can include not only the base form of each word but also its derivative forms, such as plurals, tenses, or adjective forms, to capture a wider range of linguistic variations.

In examples, the out-of-distribution text data 302 may be distinguishable from the class names or categories associated with the in-distribution data. While the in-distribution data typically consists of a limited set of predefined classes or categories, the out-of-distribution text data 302 can encompass a much broader and more diverse set of words that may not be directly related to the specific classes or categories of interest. This distinction allows the system 300 to generate out-of-distribution text samples 306 that are representative of the vast linguistic space beyond the in-distribution data.

As described in FIG. 2, the prompt template(s) 208 can be patterns or structures that specify how the out-of-distribution text data 302 should be combined or arranged to form the out-of-distribution text samples 306. The prompt template(s) 208 can include placeholders or variables that are filled with specific words from the out-of-distribution text data 302. The use of prompt template(s) 208 allows for the generation of diverse and representative out-of-distribution text samples 306.

In some aspects, the out-of-distribution text samples 306 can be generated by combining the out-of-distribution text data 302 with the prompt template(s) 208. For example, each out-of-distribution text sample 306 can be created by selecting a word from the out-of-distribution text data 302 and inserting it into a prompt template(s) 208. Accordingly, the resulting out-of-distribution text samples 306 can represent a wide range of linguistic variations and concepts that are distinct from the in-distribution data.

The example prompt(s) 210, including example prompts 210A, 210B, and 210C, can illustrate specific instances of the out-of-distribution text samples 306 generated using the prompt template(s) 208 and the out-of-distribution text data 302. In the example shown in FIG. 3, the example prompts 210A, 210B, and 210C include phrases such as “a photo of a { }”, “a plastic { }”, and “a drawing of a { }”, where the placeholders “{ }” are filled with words from the out-of-distribution text data 302, such as “stacking,” “stackless,” or “stackman.”

The out-of-distribution text samples 306 can be generated by randomly sampling or selecting words from the out-of-distribution text data 302 and inserting them into the prompt template(s) 208. The number and diversity of the out-of-distribution text samples 306 can be adjusted based on the desired coverage and variability of the out-of-distribution text samples 306.

The model 212, as described in FIG. 2, can be a trained machine learning model that takes the out-of-distribution text samples 306 as input and generates corresponding out-of-distribution embeddings 308. In some aspects, the model 212 can process each out-of-distribution text sample 306 and map it to a dense vector representation in an embedding space. The resulting out-of-distribution embeddings 308 can therefore, capture the semantic and contextual information present in the out-of-distribution text samples 306.

In examples, the out-of-distribution embeddings 308, including example out-of-distribution embeddings 308A, 308B, and 308N, represent the output of the model 212 for the corresponding out-of-distribution text samples 306. Each out-of-distribution embedding, such as 308A, 308B, or 308N, can be a dense vector that encodes the relevant features and characteristics of the associated out-of-distribution text sample. These embeddings can be used by downstream components, such as for training the ID/GOD classifier 112 in FIG. 1, to make decisions about whether an input data sample is more likely an in-distribution sample or an out-of-distribution sample. In some aspects, the out-of-distribution embeddings 308 can be stored and reused for efficient classification or comparison purposes. The number and diversity of out-of-distribution embeddings 308 can be determined based on the complexity of the out-of-distribution text data 302 and the desired performance of the OOD detection system.

### Example System for Obtaining Trained Out-Of-Distribution Embeddings

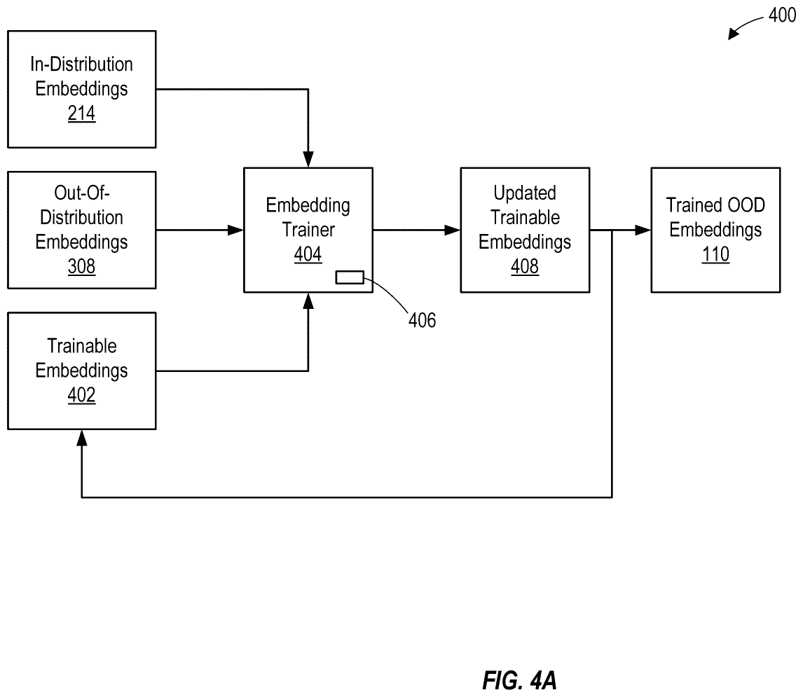

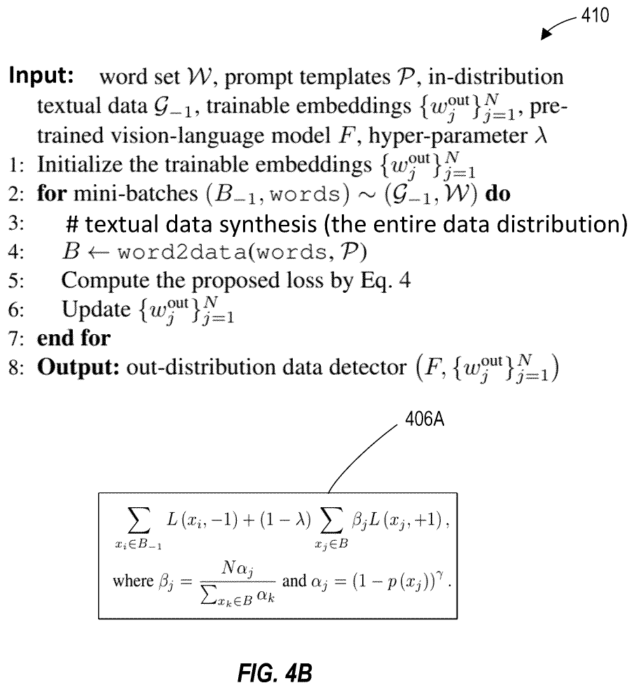

FIG. 4A illustrates a block diagram of an example training system 400 for obtaining trained out-of-distribution embeddings 110, in accordance with aspects of the present disclosure. The training system 400 can include, in-distribution embeddings 214, out-of-distribution embeddings 308, trainable embeddings 402, an embedding trainer 404, a loss function 406, updated trainable embeddings 408, and trained out-of-distribution embeddings 110.

In examples, the in-distribution embeddings 214, as described in FIG. 2, represent the dense vector representations of the in-distribution text samples in the embedding space. These embeddings can capture the semantic and contextual information of the in-distribution data and serve as reference points for the training process. The out-of-distribution embeddings 308, as described in FIG. 3, can represent the dense vector representations of the out-of-distribution text samples in the embedding space. These embeddings capture the semantic and contextual information of the out-of-distribution data and are used as inputs to the embedding trainer 404.

In examples, the trainable embeddings 402 can be initialized embeddings that are updated during the training process to obtain the trained out-of-distribution embeddings 110. In some aspects, the number of trainable embeddings 402 can be set to match the number of out-of-distribution embeddings 308, establishing a one-to-one correspondence. Alternatively, a smaller number of trainable embeddings 402, such as 10, 20, or 100, can be used to reduce computational complexity while still capturing the essential characteristics of the out-of-distribution data.

In some aspects, the initialization process for the trainable embeddings 402 can vary depending on the specific implementation. In some examples, the trainable embeddings 402 can be initialized randomly, using techniques such as random normal initialization. In other examples, the trainable embeddings 402 can be initialized using pre-trained word embeddings, such as Word2Vec or GloVe, to leverage semantic information captured by these embeddings. In certain aspects, during a training process the embedding trainer 404 can update the trainable embeddings 402 based on a loss function 406. For example, the embedding trainer 404 can take the in-distribution embeddings 214, out-of-distribution embeddings 308, and trainable embeddings 402 as inputs and iteratively adjust the trainable embeddings 402 to minimize the loss function 406.

In certain aspects, the loss function 406 can be a mathematical function that measures the dissimilarity between the trainable embeddings 402 and the in-distribution embeddings 214, while also considering the out-of-distribution embeddings 308. The goal of the training process may be to update the trainable embeddings 402 such that they are dissimilar from the in-distribution embeddings 214 and capture the characteristics of the out-of-distribution data. In certain aspects, the loss function 406 is designed to encourage or incentivize the trainable embeddings 402 to be dissimilar or distinct from the set of ID text embeddings 214 during the training process. In some aspects, the loss function 406 can achieve this by penalizing similarity between the trainable embeddings 402 and the ID text embeddings 214. In other words, the loss function 406 drives, encourages, incentivizes, and/or guides the trainable embeddings 402 to be different from the ID text embeddings 214 by imposing a penalty when the embeddings are too similar. This encourages the trainable embeddings 402 to capture characteristics that are unique to OOD data and distinct from ID data.

In some aspects, the loss function 406 can be designed to maximize the distance or dissimilarity between the trainable embeddings 402 and the in-distribution embeddings 214, while minimizing the distance or dissimilarity between the trainable embeddings 402 and the out-of-distribution embeddings 308. Such a loss function 406 can encourage the trainable embeddings 402 to move away from the in-distribution embeddings 214 and towards the out-of-distribution embeddings 308 in the embedding space.

During the training process, the embedding trainer 404 can compute the loss function 406 for each batch of embeddings and updates the trainable embeddings 402 using optimization techniques such as gradient descent or Adam optimizer. The training process may be repeated iteratively until a desired level of convergence or a maximum number of epochs is reached.

In examples, the updated trainable embeddings 408 may be the result of the training process, representing the adjusted embeddings that capture the characteristics of the out-of-distribution data. These updated trainable embeddings 408 can then be used as the trained out-of-distribution embeddings 110, which can be utilized by the ID/OOD classifier 112 (FIG. 1) to make decisions about whether an input data sample is more likely an in-distribution sample or an out-of-distribution sample.

In some aspects, the trained out-of-distribution embeddings 110 can be further fine-tuned or adapted to specific domains or tasks, depending on the requirements of the OOD detection system. The training process can also be extended to incorporate additional techniques, such as regularization or data augmentation, to improve the robustness and generalization of the trained out-of-distribution embeddings 110.

FIG. 4B depicts details of an example training process 410 in accordance with examples of the present disclosure. With reference to FIGS. 2-4, the example training process 410 may involve the following steps:

(1) Obtain in-distribution text data 202 (FIG. 2) and out-of-distribution text data 302 (FIG. 3). In certain aspects, the in-distribution text data 202 may represent known classes or categories of interest (e.g., in-distribution textual data g₋₁), while the out-of-distribution text data 302 (e.g., word set W), consists of a diverse set of words that are not directly related to the in-distribution data.

(2) Generate in-distribution text samples 206 (FIG. 2) by combining the in-distribution text data 202 with prompt template(s) 208. For example, if the in-distribution text data 202 includes words like “dog,” “cat,” and “bird,” the prompt template 208 “A photo of a {word}” can be used to generate in-distribution text samples 206 such as “A photo of a dog,” “A photo of a cat,” and “A photo of a bird.”

(3) Process the in-distribution text samples 206 using a trained model 212 (FIG. 2) to obtain in-distribution embeddings 214. In certain aspects, the trained model 212 can be a language model like BERT or GPT that captures semantic and contextual information. The resulting in-distribution embeddings 214 can represent the dense vector representations of the in-distribution text samples 206 in the embedding space.

(4) Generate out-of-distribution text samples 306 (FIG. 3) by combining the out-of-distribution text data 302 with prompt template(s) 208. For example, if the out-of-distribution text data 302 includes words like “car,” “tree,” and “building,” the prompt template 208 “A photo of a {word}” can be used to generate out-of-distribution text samples 306 such as “A photo of a car,” “A photo of a tree,” and “A photo of a building.”

(5) Process the out-of-distribution text samples 306 using the same (or similar) previously trained model 212 (FIG. 3) to obtain out-of-distribution embeddings 308. In certain aspects, the resulting out-of-distribution embeddings 308 represent the dense vector representations of the out-of-distribution text samples 306 in the embedding space.

(6) Initialize trainable embeddings 402 (FIG. 4) (e.g.,

$${\{ {w}_{j}^{out} \}}_{j = 1}^{N} )$$

that can be updated during the training process to capture the characteristics of the out-of-distribution data. In certain aspects, the trainable embeddings 402 can be initialized randomly or using pre-trained word embeddings like Word2Vec or GloVe.

(7) Use an embedding trainer 404 (FIG. 4) to update the trainable embeddings 402 based on a loss function 406. In certain aspects, the embedding trainer 404 can take the in-distribution embeddings 214, out-of-distribution embeddings 308, and trainable embeddings 402 as inputs and iteratively adjust the trainable embeddings 402 to minimize the loss function 406A. In some examples, the embedding trainer 404 can operate on batches comprising subsets of the in-distribution embeddings 214, out-of-distribution embeddings 308, and trainable embeddings 402. During a training process, the embedding trainer 404 can compute the loss function 406 for each batch of embeddings and update the trainable embeddings 402 using optimization techniques like gradient descent or Adam optimizer.

In certain aspects, the training process is repeated iteratively until convergence or a maximum number of epochs is reached. In some examples, the in-distribution embeddings 214 out-of-distribution embeddings 308 are generated as needed.

In certain aspects, the updated trainable embeddings 408 (FIG. 4A) resulting from the training process can represent the adjusted embeddings that capture the characteristics of the out-of-distribution data. In certain aspects, these updated trainable embeddings 408 can be used as the trained out-of-distribution embeddings 110, which can be utilized by the ID/OOD classifier 112 (FIG. 1) to make decisions about whether an input data sample is more likely an in-distribution sample or an out-of-distribution sample.

In certain aspects, the trained out-of-distribution embeddings 110 can be further fine-tuned or adapted to specific domains or tasks, depending on the requirements of the OOD detection system. In some examples, the training process can also incorporate additional techniques, such as regularization or data augmentation, to improve the robustness and generalization of the trained out-of-distribution embeddings 110.

FIG. 4B additionally illustrates an example loss function 406A that can be used in the training process of the out-of-distribution detector, in accordance with aspects of the present disclosure. The loss function 406A can be designed to optimize the trainable embeddings 402 to capture the characteristics of the out-of-distribution data while being dissimilar from the in-distribution embeddings 214.

The loss function 406A may comprise two terms: the first term is directed to the in-distribution data, while the second term considers the overall data distribution, including both in-distribution and out-of-distribution samples.

The first term of the loss function 406A is given by Equation (1):

$${\sum }_{{x}_{i} ∈ {B}_{- 1}} L ( {x}_{i} , - 1 ) + ( 1 - λ ) {\sum }_{{x}_{j} ∈ B} {B}_{j} L ( {x}_{j} , + 1 ) \qquad Equation 1$$

where

$${B}_{j} = \frac{N {α}_{j}}{{\sum }_{{x}_{k} ∈ B} {α}_{k}} and {α}_{j} = {( 1 - p ( {x}_{j} ) )}^{γ} ,$$

L(xᵢ, −1) represents the loss for an in-ZxkEB ak distribution sample xᵢ, and L(xⱼ, +1) represents the loss for a sample xⱼ from the overall data distribution B. The summation Σ_(x_i∈B_(−1)) iterates over the in-distribution samples in the mini-batch B_{{-1)}, while the summation Σ_(x_j∈B) iterates over all the samples in the mini-batch B, which includes both in-distribution and out-of-distribution samples. The hyperparameter λ in the first term can control the balance between the in-distribution and overall data distribution losses. In some aspects, it determines the relative importance of the in-distribution samples in the loss calculation. The second term of the loss function 406A is a weighted sum of the individual losses for the samples in the mini-batch B, where the weights Bⱼ are given by Equation (2):

$${B}_{j} = \frac{N {α}_{j}}{{\sum }_{{x}_{k} ∈ B} {α}_{k}} and {α}_{j} = {( 1 - p ( {x}_{j} ) )}^{γ} \qquad Equation 2$$

In this example, Naⱼ, where α₁ '₂ (1−p(xⱼ))^{Y} represents a predicted probability of the sample xⱼ being in-distribution, and γ acts as a focusing parameter that adjusts the down-weighting of easier examples. The weights βⱼ and αⱼ can be calculated based on the predicted probabilities and the focusing parameter γ.

The term αₖ in the denominator of βⱼ can represent the summation of αₖ over samples xₖ in a mini-bath B. This summation helps to ensure that the weights βⱼ can be normalized within the minibatch.

The individual loss terms L(xᵢ, −1) and L(xⱼ, +1) in the loss function 406A can be computed using various loss functions, such as cross-entropy loss. The choice of the specific loss function depends on the requirements and characteristics of the OOD detection system. During a training process, the embedding trainer 404 computes the loss function 406A for each mini-batch of embeddings and updates the trainable embeddings 402 using optimization techniques like gradient descent or Adam optimizer. The gradients of the loss function 406A with respect to the trainable embeddings 402 are calculated, and the trainable embeddings (e.g., 402 FIG. 4A) are adjusted iteratively to minimize the loss.

By minimizing the loss function 406A, the trainable embeddings 402 can be encouraged to be dissimilar from the in-distribution embeddings 214 and capture the characteristics of the out-of-distribution data. The focusing parameter γ in the weights βⱼ and αⱼ helps to down-weight the contribution of easier examples and focus more on more difficult examples, which can be beneficial for OOD detection tasks.

The training process can continue for multiple epochs until convergence or until a desired level of performance is achieved. The resulting updated trainable embeddings 408 can then be used as the trained out-of-distribution embeddings 110, which can be utilized by the ID/GOD classifier 112 (FIG. 1) to make decisions about whether an input data sample is more likely an in-distribution sample or an out-of-distribution sample.

### Example Diagram for Detecting Out-Of-Distribution Data

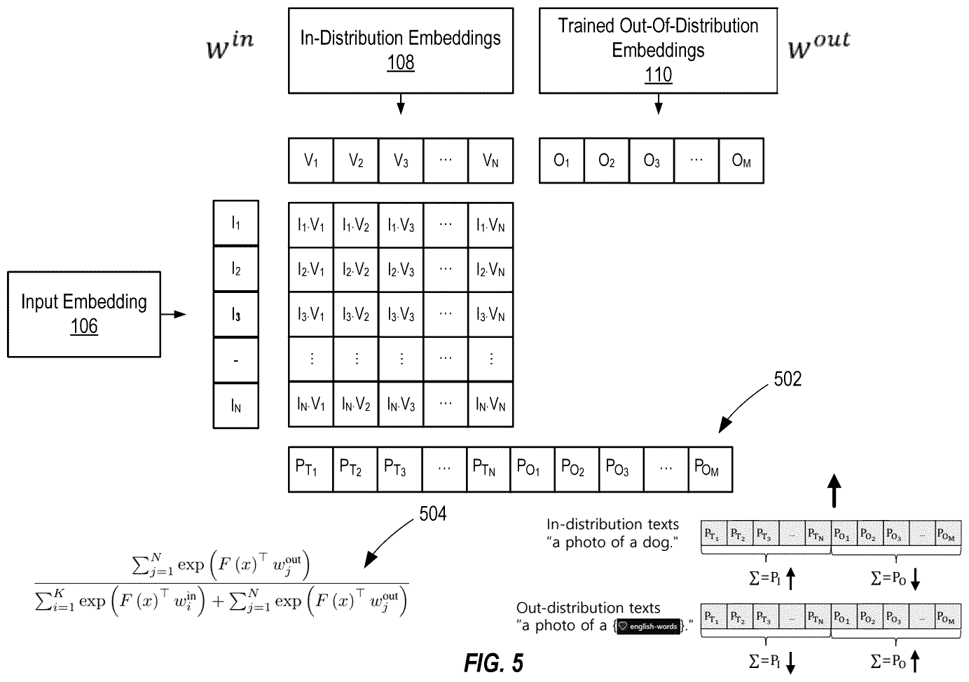

FIG. 5 illustrates an example process 500 for detecting out-of-distribution data using a trained detector, in accordance with aspects of the present disclosure. The process 500 can begin by obtaining an input 102, such as an image, text, or any other type of data that the system aims to classify as either in-distribution or out-of-distribution. The input embedding 106 can be generated by processing the input 102 using the input embedding generator 104, which can be a pre-trained vision-language model.

In the example shown in FIG. 5, the input embedding 106 is denoted as a vector [I₁, I₂, I₃, . . . , I_{N}], where each element represents a specific feature or dimension of the input data in the embedding space. The dimensionality of the input embedding 106 can vary depending on the complexity of the input data and the architecture of the input embedding generator 104 (FIG. 1).

The in-distribution embeddings 108, as described in FIG. 1 and FIG. 2, represent the dense vector representations of the in-distribution text samples in the embedding space. These embeddings can capture the semantic and contextual information of the in-distribution data and serve as reference points for the classification task. In the example shown in FIG. 5, the in-distribution embeddings 108 are denoted as a matrix [V₁, V₂, V₃, . . . , V_{N}], where each column represents a specific in-distribution embedding. The number of in-distribution embeddings 108 can vary based on the number of classes or categories in the in-distribution data.

The trained out-of-distribution embeddings 110, as described in FIG. 1 and FIG. 4, represent the dense vector representations of the out-of-distribution text samples in the embedding space. These embeddings can be obtained through the training process described in FIG. 4 and capture the characteristics of the out-of-distribution data. In the example shown in FIG. 5, the trained out-of-distribution embeddings 110 are denoted as a matrix [O₁, O₂, O₃, . . . , O_{M}], where each column represents a specific trained out-of-distribution embedding. The number of trained out-of-distribution embeddings 110 can vary based on the desired granularity and coverage of the out-of-distribution data.

In certain aspects, the classification process involves comparing the input embedding 106 with the in-distribution embeddings 108 and trained out-of-distribution embeddings 110 to determine the likelihood of the input data sample belonging to the in-distribution or out-of-distribution classes. One approach for this comparison is to compute the dot product between the input embedding 106 and each of the in-distribution embeddings 108 and trained out-of-distribution embeddings 110.

That is, as part of the process 500, the in-distribution embeddings 108 (denoted as V₁, V₂, . . . , V_{N}) and the trained out-of-distribution embeddings 110 (denoted as O¹, O² . . . , O^{M}) can be retrieved. As shown in FIG. 5, an example decision score for determining whether the input data sample is in-distribution or out-of-distribution can be calculated using equation (3) (e.g., 504):

$$\frac{{\sum }_{j = 1}^{N} exp ( {F ( x )}^{T} {w}_{j}^{out} )}{{\sum }_{i = 1}^{K} exp ( {F ( x )}^{T} {w}_{i}^{in} ) + {\sum }_{j = 1}^{N} exp ( {F ( x )}^{T} {w}_{j}^{out} )} \qquad Equation 3$$

where F(x)^{T} represents the input data embedding 106,

$${w}_{i}^{in}$$

represents the i^{th} in-distribution embedding,

$${w}_{j}^{out}$$

represents the j^{th} trained out-of-distribution embedding, K is the total number of in-distribution embeddings, and N is the total number of trained out-of-distribution embeddings. In examples, Equation 3 calculates the exponential of the dot product between the input data embedding F(x)^{T} and each of the in-distribution embeddings

$${w}_{i}^{in}$$

and out-of-distribution embeddings

$${w}_{j}^{out} .$$

The sum of the exponential values for the in-distribution embeddings is divided by the sum of the exponential values for both the in-distribution embeddings and the maximum exponential value among the out-of-distribution embeddings. This normalization works to ensure that the decision score is between 0 and 1.

In some aspects, if the input data sample is in-distribution, the dot product between the input data embedding and the in-distribution embeddings will be high, resulting in larger exponential values and a higher decision score. Conversely, if the input data sample is out-of-distribution, the dot product between the input data embedding and the out-of-distribution embeddings will be high, leading to smaller exponential values and a lower decision score. The decision score can be compared to a predetermined threshold to make the final classification decision. If the decision score is above the threshold, the input data sample can be classified as out-of-distribution, indicating that it belongs to an unknown or unseen class. If the decision score is below the threshold, the input data sample can be classified as in-distribution, suggesting that it belongs to one of the known classes. The classification result 114 can be outputted, which can include the binary decision (in-distribution or out-of-distribution) along with the corresponding decision score.

In certain aspects, FIG. 5 illustrates the relationship between the input embedding 106, in-distribution embeddings 108, and trained out-of-distribution embeddings 110 in the context of the classification task. By comparing the input embedding 106 with these reference embeddings, the OOD detection system can determine whether the input data sample belongs to the in-distribution or out-of-distribution classes, enabling effective detection and handling of out-of-distribution data.

### Example Artificial Intelligence System for Detecting Out-Of-Distribution Data

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

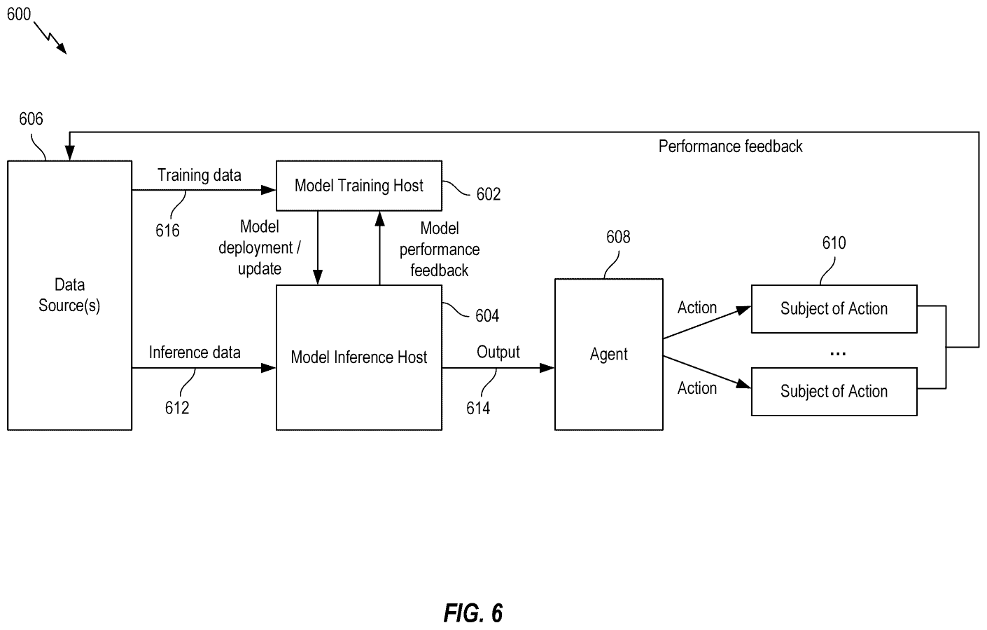

FIG. 6 is a diagram illustrating an example AI architecture 600 that may be used to implement the out-of-distribution (OOD) detection techniques described in this disclosure. As illustrated, the architecture 600 can include multiple logical entities, such as a model training host 602 for training the OOD detection model, a model inference host 604 for running inference using the trained model, data source(s) 606 providing training and inference data, and an agent 608 that utilizes the model's output. This AI architecture could be used to enable the example disclosed OOD detection techniques in various machine learning applications.

The model inference host 604, in the architecture 600, can be configured to run an OOD detection model based on inference data 612 provided by data source(s) 606. The inference data 612 may include input data samples, such as images, text, or other types of data that need to be classified as in-distribution or out-of-distribution. The model inference host 604 may produce an output 614 (e.g., a classification result indicating whether the input data is in-distribution or out-of-distribution) based on the inference data 612, which is then provided as input to the agent 608.

The agent 608 may be an element or entity that utilizes the output of the OOD detection model hosted by the model inference host 604. The agent 608 could be a software component, a hardware accelerator, or a system that leverages the OOD detection results produced by the model for various downstream tasks such as data filtering, anomaly detection, or decision-making processes.

For example, if the output 614 from the model inference host 604 indicates that an input image is out-of-distribution, the agent 608 may be a content moderation system that flags the image for further review or takes appropriate actions based on predefined policies. As another example, if the output 614 indicates that an input text document is in-distribution, the agent 608 could be a sentiment analysis model that processes the document further to determine its sentiment.

After receiving the output 614 from the model inference host 604, the agent 608 may determine how to utilize it. For instance, if the agent 608 is a content moderation system and the output indicates an out-of-distribution image, it may apply specific moderation rules or trigger human intervention. If the agent 608 decides to use the output 614, it may apply it to the subject of the action 610, which represents the data being processed or analyzed. In the content moderation example, the subject of action 610 would be the image being moderated. In some cases, the agent 608 and subject of action 610 may be tightly integrated.

The data source(s) 606 may be configured to collect data used as training data 616 for the model training host 602 to train the OOD detection model. The data source(s) 606 may also provide inference data 612 to the model inference host 604. This data could come from various entities and may include the subject of action 610. For example, for training an OOD detection model for image classification, the data source(s) 606 may collect in-distribution images and their corresponding class labels, as well as out-of-distribution images. The model training host 602 can then monitor the model's performance on this data to determine if retraining or fine-tuning is necessary to improve the OOD detection accuracy.

The data source(s) 606 may be configured for collecting data that is used as training data 616 for training the OOD detection model. The data source(s) 606 may also provide inference data 612 (also referred to as input data) for feeding the trained model during inference. In particular, the data source(s) 606 may collect data relevant to the OOD detection task, such as images, text documents, or other types of data. This data may come from various sources, including the subject of action 610, which represents the data being processed by the model. The collected data is provided to the model training host 602 for training and fine-tuning the OOD detection model. For example, after the subject of action 610 (e.g., an input image) is processed by the model, the output 614 (e.g., a classification result) may be compared to ground truth labels to evaluate the model's performance. If the output 614 is not sufficiently accurate, this performance feedback may be used by the model training host 602 to further train the model using the disclosed OOD detection techniques, aiming to improve its classification accuracy. The updated model may then be deployed to the model inference host 604.

In certain aspects, the model training host 602 may be deployed at or with the same or a different entity than that in which the model inference host 604 is deployed. For example, in order to offload model training processing, which can impact the performance of the model inference host 604, the model training host 602 may be deployed at a model server as further described herein. Further, in some cases, training and/or inference may be distributed amongst devices in a decentralized or federated fashion.

In some aspects, an OOD detection model utilizing the techniques described in this disclosure is deployed at or on a computing device for enhancing the performance of classification tasks. More specifically, a model inference host, such as model inference host 604 in FIG. 6, may be deployed at or on the computing device for running the OOD detection model to classify input data samples as in-distribution or out-of-distribution.

In some other aspects, the OOD detection model is deployed at or on an embedded system or mobile device for enabling efficient on-device inference. More specifically, a model inference host, such as model inference host 604 in FIG. 6, may be deployed at or on the embedded system or mobile device for running the model to obtain accurate OOD detection results while meeting resource constraints.

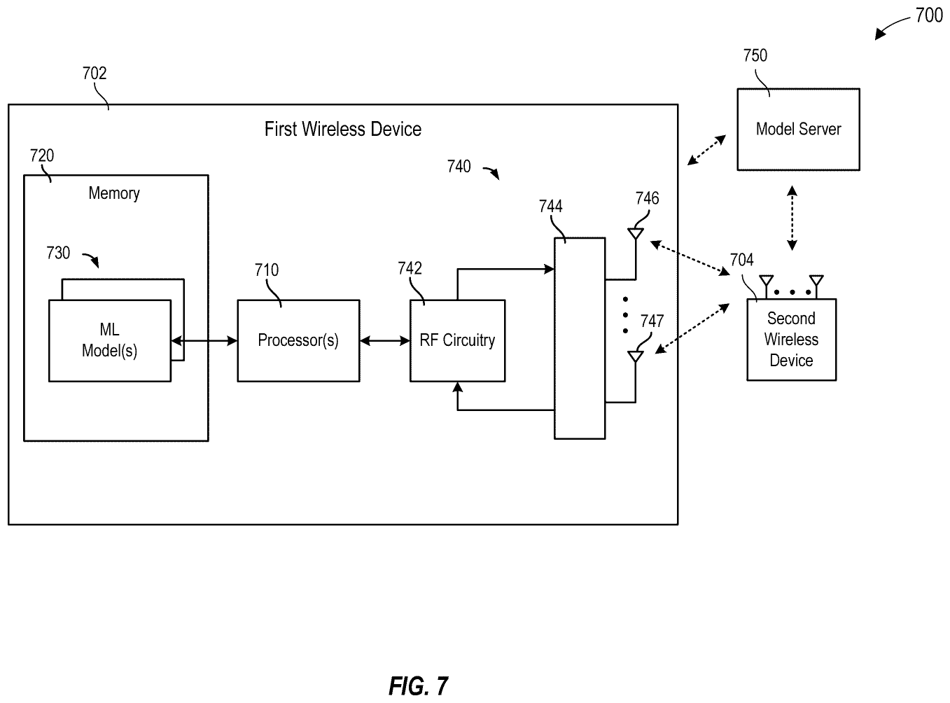

FIG. 7 illustrates an example AI architecture 700 of a first computing device 702 that is in communication with a second computing device 704. The first computing device 702 may be a server or cloud computing platform as described herein with respect to FIG. 6. Similarly, the second computing device 704 may be an embedded system or mobile device as described herein with respect to FIG. 6. Note that the AI architecture of the first computing device 702 may be applied to the second computing device 704.

The first computing device 702 may be, or may include, a chip, system on chip (SoC), a system in package (SiP), chipset, package or device that includes one or more processors, processing blocks or processing elements (collectively “the processor 710”) and one or more memory blocks or elements (collectively “the memory 720”).

As an example, in a model inference mode, the processor 710 may transform input data (e.g., images, text documents) into a format suitable for the OOD detection model. The processor 710 may then run the model on the formatted input data to generate an output classification. The processor 710 may be coupled to a transceiver 740 for transmitting the output classification to and/or receiving input data from one or more connected devices 746. The transceiver 740 includes interface circuitry 742 and 744 for converting between the digital signals of the processor and any transmission protocol used by the connected devices 746. The connected devices 746 may be sensors, actuators, displays, or storage that provide input to or consume the output from the model.

When receiving input data via the connected devices 746 (e.g., from the second computing device 704), the transceiver interface circuitry 742 and 744 may convert the received signals to a baseband frequency and then to digital signals for processing by the processor 710. The processor 710 may format the digital input signals and feed them into the OOD detection model for inference.

One or more ML models 730 may be stored in the memory 720 and accessible to the processor(s) 710. In certain cases, different ML models 730 with different characteristics may be stored in the memory 720, and a particular ML model 730 may be selected based on its characteristics and/or application as well as characteristics and/or conditions of first computing device 702 (e.g., a power state, a mobility state, a battery reserve, a temperature, etc.). For example, the ML models 730 may have different inference data and output pairings (e.g., different types of inference data produce different types of output), different levels of accuracies (e.g., 80%, 90%, or 95% accurate) associated with the predictions (e.g., the output 614 of FIG. 6), different latencies (e.g., processing times of less than 10 ms, 100 ms, or 1 second) associated with producing the predictions, different ML model sizes (e.g., file sizes), different coefficients or weights, etc.

The processor 710 may use the ML model 730 to produce output data (e.g., the output 614 of FIG. 6) based on input data (e.g., the inference data 612 of FIG. 6), for example, as described herein with respect to the inference host 604 of FIG. 6. The ML model 730 may be used to perform any of various AI-enhanced tasks, such as those listed above.

As an example, the ML model 730 may take an input data sample, such as an image or a text document, to predict whether it is in-distribution or out-of-distribution using one or more example OOD detection techniques previously described. The input data may include, for example, images, text documents, or other types of data that need to be classified. The output data may include, for example, a classification result indicating whether the input data sample is in-distribution or out-of-distribution, which is obtained by comparing the input embedding with the in-distribution embeddings and trained out-of-distribution embeddings within the model. In certain aspects, the output classification may be considered a “virtual” result in that it is not directly measured but rather inferred by the model based on the learned embeddings and classification boundaries. Note that other input data and/or output data may be used in addition to or instead of the examples described herein, depending on the specific OOD detection task and the available data sources.

In certain aspects, a model server 750 may perform any of various ML model lifecycle management (LCM) tasks for the first computing device 702 and/or the second computing device 704. The model server 750 may operate as the model training host 602 and update the ML model 730 using training data. In some cases, the model server 750 may operate as the data source 606 to collect and host training data, inference data, and/or performance feedback associated with an ML model 730. In certain aspects, the model server 750 may host various types and/or versions of the ML models 730 for the first computing device 702 and/or the second computing device 704 to download.

In some cases, the model server 750 may monitor and evaluate the performance of the ML model 730 that utilizes the OOD detection techniques to trigger one or more lifecycle management (LCM) tasks. For example, the model server 750 may determine whether to activate or deactivate the use of a particular OOD detection model at the first computing device 702 and/or the second computing device 704, based on factors such as the accuracy requirements, computational budget, and energy constraints of each device. The model server 750 may then provide instructions to the respective devices to manage their model usage accordingly. In some cases, the model server 750 may determine whether to switch to a different variant of the OOD detection ML model 730 at the first computing device 702 and/or the second computing device 704, based on changes in the operating conditions or performance objectives. For instance, the model server may instruct a device to switch from a complex model with high accuracy to a simpler model with lower latency when the battery level falls below a threshold. In yet further examples, the model server 750 may act as a central coordinator for collaborative learning of OOD detection models across multiple devices, using techniques such as federated learning to train a global model from locally-computed updates while preserving data privacy.

### Example Artificial Intelligence Model

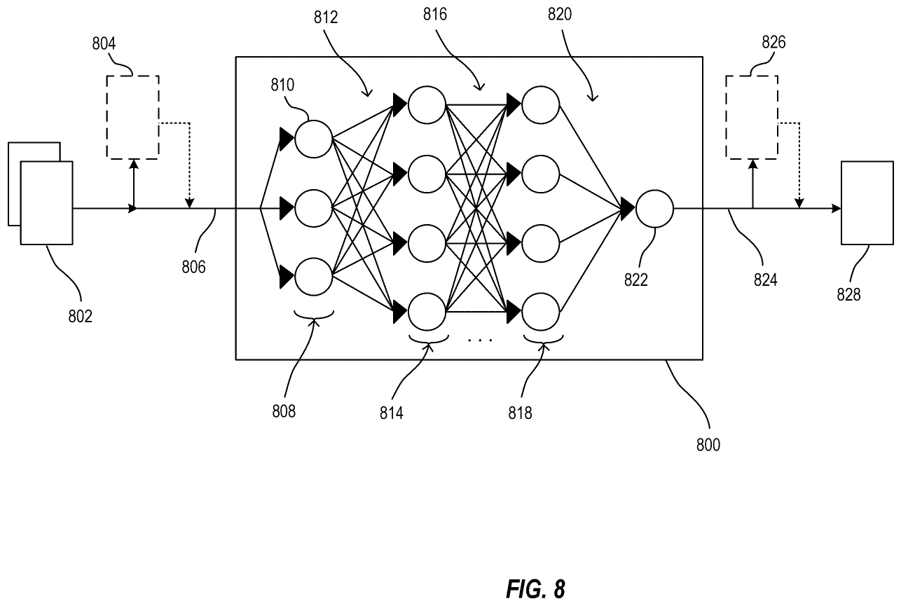

FIG. 8 is an illustrative block diagram of an example artificial neural network (ANN) 800 that may be used to implement the OOD detection techniques described in this disclosure.

ANN 800 may receive input data 806 which may include one or more bits of data 802, pre-processed data output from pre-processor 804 (optional), or some combination thereof. Here, data 802 may include training data, verification data, application-related data, or the like, e.g., depending on the stage of development and/or deployment of ANN 800. Pre-processor 804 may be included within ANN 800 in some other implementations. Pre-processor 804 may, for example, process all or a portion of data 802 which may result in some of data 802 being changed, replaced, deleted, etc. In some implementations, pre-processor 804 may add additional data to data 802.

ANN 800 includes at least one first layer 808 of artificial neurons 810 (e.g., perceptrons) to process input data 806 and provide resulting first layer output data via edges 812 to at least a portion of at least one second layer 814. Second layer 814 processes data received via edges 812 and provides second layer output data via edges 816 to at least a portion of at least one third layer 818. Third layer 818 processes data received via edges 816 and provides third layer output data via edges 820 to at least a portion of a final layer 822 including one or more neurons to provide output data 824. All or part of output data 824 may be further processed in some manner by (optional) post-processor 826. Thus, in certain examples, ANN 800 may provide output data 828 that is based on output data 824, post-processed data output from post-processor 826, or some combination thereof. Post-processor 826 may be included within ANN 800 in some other implementations. Post-processor 826 may, for example, process all or a portion of output data 824 which may result in output data 828 being different, at least in part, to output data 824, e.g., as result of data being changed, replaced, deleted, etc. In some implementations, post-processor 826 may be configured to add additional data to output data 824. In this example, second layer 814 and third layer 818 represent intermediate or hidden layers that may be arranged in a hierarchical or other like structure. Although not explicitly shown, there may be one or more further intermediate layers between the second layer 814 and the third layer 818.

The structure and training of artificial neurons 810 in the various layers may be tailored to specific requirements of the OOD detection application. Within a given layer of ANN 800, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 606 in FIG. 6). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 800 and a number of layers and a number of artificial neurons in each layer, as well as selecting activation functions, a loss function, training processes, etc. Once an initial model has been designed, training of the model may be conducted using training data. Training data may include one or more datasets within which ANN 800 may detect, determine, identify or ascertain patterns. Training data may represent various types of information, including written, visual, audio, environmental context, operational properties, etc. During training, parameters of artificial neurons 810 may be changed, such as to minimize or otherwise reduce a loss function or a cost function. A training process may be repeated multiple times to fine-tune ANN 800 with each iteration.

Various ANN model structures are available for consideration in the context of OOD detection. For example, in a feedforward ANN structure, each artificial neuron 810 in a layer receives information from the previous layer and likewise produces information for the next layer. This structure may be suitable for learning the mappings between input embeddings and output classifications in the OOD detection task.

In a convolutional ANN structure, some layers may be organized into filters that extract features from data (e.g., training data and/or input data). This structure may be particularly useful for processing image or text data in the OOD detection task, as convolutional layers can learn to capture local patterns and hierarchical features.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, such as processing text data in the OOD detection task.

Other example types of ANN model structures that may be applicable to OOD detection include fully connected neural networks (FCNNs), long short-term memory (LSTM) networks, and autoencoders. FCNNs can learn complex non-linear mappings between input embeddings and output classifications, while LSTMs can capture long-term dependencies in sequential data. Autoencoders can be used to learn compact representations of in-distribution data, which can then be used to detect OOD samples based on reconstruction errors or anomaly scores.

ANN 800 or other ML models may be implemented in various types of processing circuits along with memory and applicable instructions therein, for example, as described herein with respect to FIGS. 6 and 7. For example, general-purpose hardware circuits, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models for OOD detection tasks.

### Example Operations for Detecting Out-Of-Distribution Data

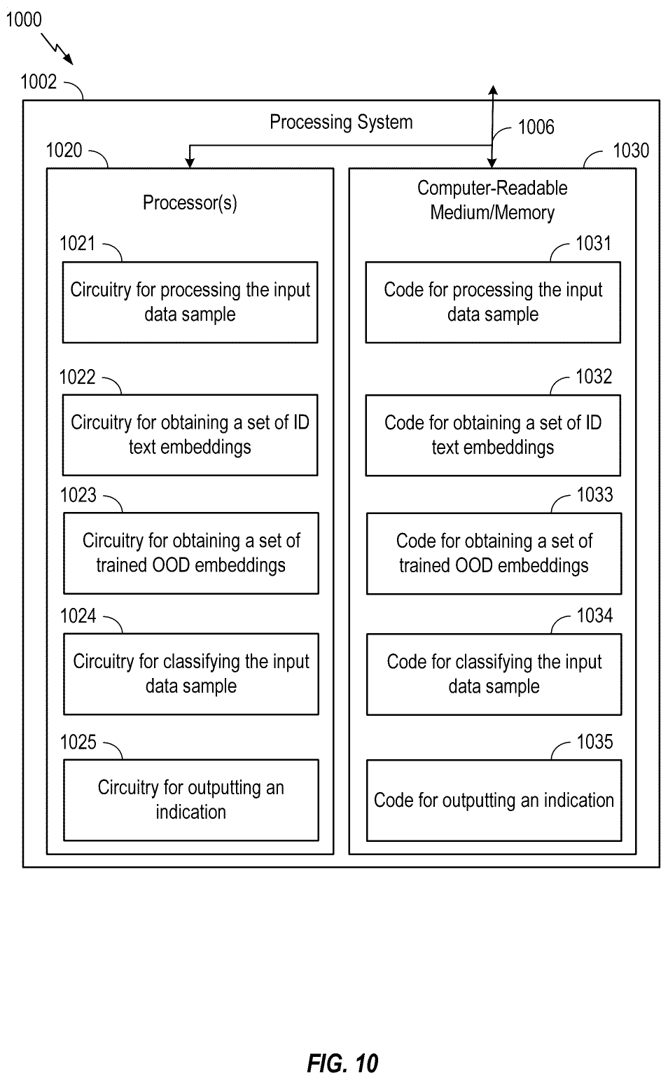

In one aspect, method 900, or any aspect related to it, may be performed by an apparatus, such as processing system 1000 of FIG. 10, which includes various components operable, configured, or adapted to perform the method 900.

Method 900 starts at block 902 with process an input data sample using a trained model to generate an input data embedding.

Method 900 continues to block 903 with obtaining a set of in-distribution (ID) text embeddings.

Method 900 continues to block 903 with obtaining a set of trained OOD embeddings.

Method 900 continues to block 903 with classifying the input data sample as OOD data or ID data based on the input data embedding, the set of ID text embeddings, and the set of trained OOD embeddings

Method 900 then ends at block 903 with outputting an indication of whether the input data is classified as OOD data or ID data based on the classification.

In some embodiments of method 900, classifying the input data sample as OOD data or ID data comprises: generating a set of ID probability scores based on the input data embedding and each ID text embedding in the set of ID text embeddings; generating a set of OOD probability scores based on the input data embedding and each trained OOD embedding in the set of trained OOD embeddings; and combining the set of ID probability scores and the set of OOD probability scores to generate an overall OOD probability score.

In some embodiments of method 900, classifying the input data sample as OOD data or ID data further comprises: comparing the overall OOD probability score to a threshold; and classifying the input data sample as OOD data if the overall OOD probability score satisfies the threshold.

In some embodiments of method 900, generating the set of ID probability scores comprises calculating a dot product between the input data embedding and each ID text embedding in the set of ID text embeddings.

In some embodiments of method 900, generating the set of OOD probability scores comprises calculating a dot product between the input data embedding and each trained OOD embedding in the set of the trained OOD embeddings.

In some embodiments of method 900, combining the set of ID probability scores and the set of OOD probability scores comprises calculating a weighted sum of the set of ID probability scores and the set of OOD probability scores.

In some embodiments of method 900, the trained model comprises a vision-language model.

In some embodiments of method 900, obtaining the set of ID text embeddings comprises generating the set of ID text embeddings by processing a set of ID text samples using the trained model.

In some embodiments of method 900, obtaining the set of trained OOD embeddings comprises training a set of trainable OOD embeddings with a loss function that drives the set of trainable OOD embeddings to be dissimilar from the set of ID text embeddings.

In some embodiments of method 900, obtaining the set of trained OOD embeddings comprises: generating a set of OOD text samples using a prompt template and text data, wherein the prompt template includes one or more placeholders, and wherein each OOD text sample is generated by population of the one or more placeholders of the prompt template with a text portion of the text data; processing the set of OOD text samples using the trained model to generate a set of OOD text embeddings; and updating a set of trainable OOD embeddings based on a similarity between the OOD text embeddings and the ID text embeddings.

In some embodiments, method 900 further comprises obtaining a set of input data samples including the input data sample, wherein processing the input data comprises processing each input data sample of the set of input data samples using the trained model to generate a set of input data embeddings including the input data embedding; and classifying the input data sample comprises classifying each input data sample of the set of input data samples as OOD data or ID data based on the corresponding input data embedding of the set of input data embeddings, the set of ID text embeddings, and the set of trained OOD embeddings.

In some embodiments of method 900, the input data sample comprises at least one of an image, a video frame, or a text document.

In some embodiments, method 900 further comprises receiving, via a modem coupled to one or more antennas, a representation of the input data sample. In some aspects, the representation of the input data sample received by the modem and antennas may be a compressed version of an image that includes text. For example, the image may be compressed to reduce an amount of data transmitted. In some aspects, the representation may be a compressed version of speech that is later converted to text by a speech to text converter. In some aspects, the speech may be compressed to reduce the amount of data transmitted and then may be converted to text for further processing.

In some embodiments of method 900, the modem and the one or more antennas are integrated into one of a vehicle, an extra-reality device, or a mobile device.

In some embodiments, method 900 further comprises acquiring the input data sample from one or more image sensors integrated into one of a vehicle, an extra-reality device, or a mobile device.

In some embodiments, method 900 further comprises capturing speech input via at least one microphone; and converting the captured speech input into text (e.g., via at least one speech-to-text converter), wherein the text is used as in-distribution text data for obtaining the set of ID text embeddings.

In some embodiments, method 900 further comprises capturing, via one or more cameras, one or more images containing at least one of text, video objects, or combinations thereof; and deriving the input data sample from the one or more captured images.

In some embodiments, method 900 further comprises capturing speech input via one or more microphones; and converting the captured speech into text (e.g., via one or more speech to text converters), wherein the input data sample is based on the text converted from the captured speech.

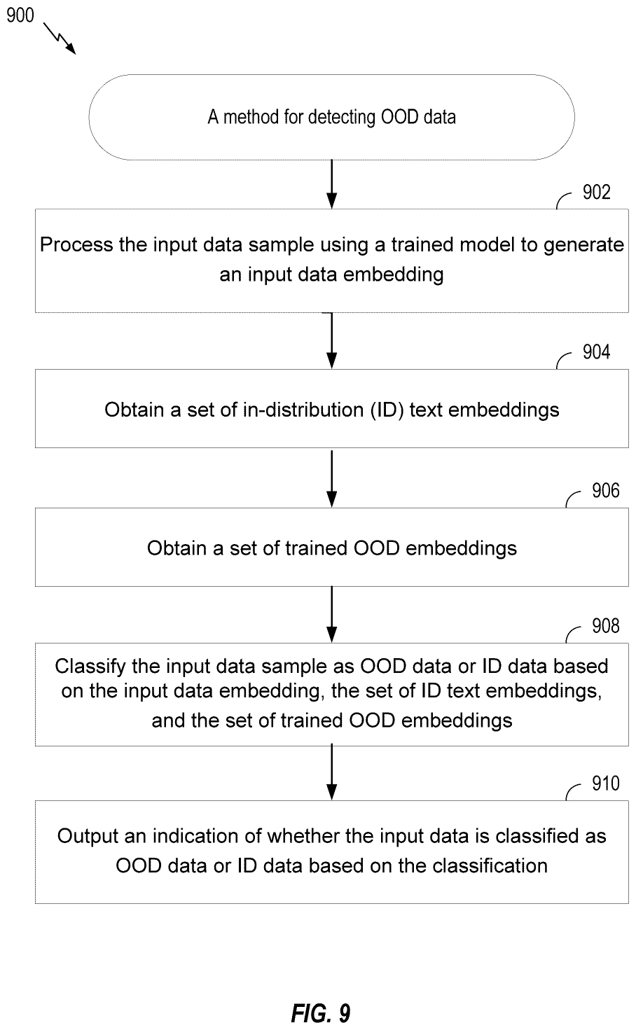

Note that FIG. 9 is just one example of a method, and other methods including fewer, additional, or alternative steps are possible consistent with this disclosure.

### Example Processing System for Detecting Out-Of-Distribution Data

FIG. 10 depicts aspects of an example processing system 1000.

The processing system 1000 includes a processing system 1002 includes one or more processors 1020. The one or more processors 1020 are coupled to a computer-readable medium/memory 1030 via a bus 1006. In certain aspects, the computer-readable medium/memory 1030 is configured to store instructions (e.g., computer-executable code) that when executed by the one or more processors 1020, cause the one or more processors 1020 to perform the method 900 described with respect to FIG. 9, or any aspect related to it, including any additional steps or sub-steps described in relation to FIG. 9.

In the depicted example, computer-readable medium/memory 1030 stores code (e.g., executable instructions) for processing the input data sample 1031, code for obtaining a set of ID text embeddings 1032, code for obtaining a set of trained OOD embeddings 1033, code for classifying the input data sample 1034, and code for outputting an indication 1035. Processing of the code 1031-1035 may enable and cause the processing system 1000 to perform the method 900 described with respect to FIG. 9, or any aspect related to it.

The one or more processors 1020 include circuitry configured to implement (e.g., execute) the code stored in the computer-readable medium/memory 1030, including circuitry for processing the input data sample 1021, circuitry for obtaining a set of ID text embeddings 1022, circuitry for obtaining a set of trained OOD embeddings 1023, circuitry for classifying the input data sample 1024, and circuitry for outputting an indication 1025. Processing with circuitry 1021-1025 may enable and cause the processing system 1000 to perform the method 900 described with respect to FIG. 9, or any aspect related to it.

### Example Clauses

Implementation examples are described in the following numbered clauses:

Clause 1: A method of detecting out-of-distribution (OOD) data, comprising: processing an input data sample using a trained model to generate an input data embedding; obtaining a set of in-distribution (ID) text embeddings; obtaining a set of trained OOD embeddings; classifying the input data sample as OOD data or ID data based on the input data embedding, the set of ID text embeddings, and the set of trained OOD embeddings; and outputting an indication of whether the input data is classified as OOD data or ID data based on the classification.

Clause 2: The method according to Clause 1, wherein classifying the input data sample as OOD data or ID data comprises: generating a set of ID probability scores based on the input data embedding and each ID text embedding in the set of ID text embeddings; generating a set of OOD probability scores based on the input data embedding and each trained OOD embedding in the set of trained OOD embeddings; and combining the set of ID probability scores and the set of OOD probability scores to generate an overall OOD probability score.

Clause 3: The method according to Clause 2, wherein classifying the input data sample as OOD data or ID data further comprises: comparing the overall OOD probability score to a threshold; and classifying the input data sample as OOD data if the overall OOD probability score satisfies the threshold.

Clause 4: The method according to Clause 2, wherein generating the set of ID probability scores comprises calculating a dot product between the input data embedding and each ID text embedding in the set of ID text embeddings.

Clause 5: The method according to Clause 2, wherein generating the set of OOD probability scores comprises calculating a dot product between the input data embedding and each trained OOD embedding in the set of trained OOD embeddings.

Clause 6: The method according to Clause 2, wherein combining the set of ID probability scores and the set of OOD probability scores comprises calculating a weighted sum of the set of ID probability scores and the set of OOD probability scores.

Clause 7: The method according to any one of Clauses 1-6, wherein the trained model comprises a vision-language model.

Clause 8: The method according to any one of Clauses 1-7, wherein obtaining the set of ID text embeddings comprises generating the set of ID text embeddings by processing a set of ID text samples using the trained model.

Clause 9: The method according to any one of Clauses 1-8, wherein obtaining the set of trained OOD embeddings comprises training a set of trainable OOD embeddings with a loss function that drives the set of trainable OOD embeddings to be dissimilar from the set of ID text embeddings.

Clause 10: The method according to any one of Clauses 1-9, wherein obtaining the set of trained OOD embeddings comprises: generating a set of OOD text samples using a prompt template and text data, wherein the prompt template includes one or more placeholders, and wherein each OOD text sample is generated by population of the one or more placeholders of the prompt template with a text portion of the text data; processing the set of OOD text samples using the trained model to generate a set of OOD text embeddings; and updating a set of trainable OOD embeddings based on a similarity between the OOD text embeddings and the ID text embeddings.

Clause 11: The method according to any one of Clauses 1-10, further comprising obtaining a set of input data samples including the input data sample, wherein processing the input data comprises processing each input data sample of the set of input data samples using the trained model to generate a set of input data embeddings including the input data embedding, and classifying the input data sample comprises classifying each input data sample of the set of input data samples as OOD data or ID data based on the corresponding input data embedding of the set of input data embeddings, the set of ID text embeddings, and the set of trained OOD embeddings.

Clause 12: The method according to any one of clauses 1-11, wherein the input data sample comprises at least one of an image, a video frame, or a text document.

Clause 13: The method according any one of Clauses 1-12, further comprising receiving, via a modem and one or more antennas, a representation of the input data sample.

Claim 14: The method according to Clause 13, further comprising one or more microphones configured to capture speech input, wherein: the one or more processors are configured to convert the speech input to text; and to obtain the ID text embeddings is based on use of the text as in-distribution text data.

Clause 15: The method according to any one of Clauses 1-14, further comprising acquiring the input data sample from one or more image sensors integrated into one of a vehicle, extra-reality device, or a mobile device.

Clause 16: The method according to any one of Clauses 1-15, further comprising: capturing speech input via at least one microphone; and converting the speech input into text, wherein the text is used as in-distribution text data for obtaining the set of ID text embeddings.

Clause 17: The method according to any one of Clauses 1-16, further comprising: capturing, via one or more cameras, one or more images containing at least one of text, video objects, or combinations thereof; and deriving the input data sample from the one or more captured images.

Clause 18: The method according to any one of Clauses 1-16, further comprising: capturing speech input via one or more microphones; and converting the captured speech into text, wherein the input data sample is based on the text.

Clause 19: One or more apparatuses, comprising: one or more memories comprising executable instructions; and one or more processors configured to execute the executable instructions and cause the one or more apparatuses to perform a method in accordance with any one of clauses 1-18.

Clause 20: One or more apparatuses, comprising: one or more memories; and one or more processors, coupled to the one or more memories, configured to cause the one or more apparatuses to perform a method in accordance with any one of Clauses 1-18.

Clause 21: One or more apparatuses, comprising: one or more memories; and one or more processors, coupled to the one or more memories, configured to perform a method in accordance with any one of Clauses 1-18.

Clause 22: One or more apparatuses, comprising means for performing a method in accordance with any one of Clauses 1-18.

Clause 23: One or more non-transitory computer-readable media comprising executable instructions that, when executed by one or more processors of one or more apparatuses, cause the one or more apparatuses to perform a method in accordance with any one of Clauses 1-18.

Clause 24: One or more computer program products embodied on one or more computer-readable storage media comprising code for performing a method in accordance with any one of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

1. An apparatus configured to detect out-of-distribution (OOD) data, comprising:
one or more memories configured to store an input data sample; and
one or more processors, coupled to the one or more memories, configured to:
process the input data sample using a trained model to generate an input data embedding;
obtain a set of in-distribution (ID) text embeddings based on in-distribution text data representative of expected input to the trained model;
obtain a set of trained OOD text embeddings based on out-of-distribution text data representative of unexpected input to the trained model;
classify the input data sample as OOD data or ID data based on the input data embedding, the set of ID text embeddings, and the set of trained OOD text embeddings, wherein to classify the input data sample as OOD data or ID data comprises to:
generate a set of ID probability scores based on the input data embedding and each ID text embedding in the set of ID text embeddings:
generate a set of OOD probability scores based on the input data embedding and each trained OOD text embedding in the set of trained OOD text embeddings; and
combine the set of ID probability scores and the set of OOD probability scores to generate an overall OOD probability score; and
output an indication of whether the input data is classified as OOD data or ID data based on the classification.

2. (canceled)

3. The apparatus of claim 1, wherein to classify the input data sample as OOD data or ID data further comprises to:
compare the overall OOD probability score to a threshold; and
classify the input data sample as OOD data if the overall OOD probability score satisfies the threshold.

4. The apparatus of claim 1, wherein to generate the set of ID probability scores comprises to calculate a dot product between the input data embedding and each ID text embedding in the set of ID text embeddings.

5. The apparatus of claim 1, wherein to generate the set of OOD probability scores comprises to calculate a dot product between the input data embedding and each trained OOD text embedding in the set of the trained OOD text embeddings.

6. The apparatus of claim 1, wherein to combine the set of ID probability scores and the set of OOD probability scores comprises to calculate a weighted sum of the set of ID probability scores and the set of OOD probability scores.

7. The apparatus of claim 1, wherein the trained model comprises a vision-language model.

8. The apparatus of claim 1, wherein to obtain the set of ID text embeddings comprises to generate the set of ID text embeddings by processing in-distribution text data comprising a set of ID text samples using the trained model.

9. The apparatus of claim 1, wherein to obtain the set of trained OOD text embeddings comprises to train a set of trainable OOD text embeddings with a loss function that drives the set of trainable OOD text embeddings to be dissimilar from the set of ID text embeddings.

10. The apparatus of claim 1, wherein to obtain the set of trained OOD text embeddings comprises to:
generate the out-of-distribution text data comprising a set of OOD text samples using a prompt template and text data, wherein the prompt template includes one or more placeholders, and wherein each OOD text sample is generated by population of the one or more placeholders of the prompt template with a text portion of the text data;
process the set of OOD text samples using the trained model to generate a set of OOD text embeddings; and
update a set of trainable OOD text embeddings based on a similarity between the OOD text embeddings and the ID text embeddings.

11. The apparatus of claim 1, wherein:
the one or more processors are further configured to:
obtain a set of input data samples;
process each input data sample of the set of input data samples using the trained model to generate a set of input data embeddings; and
classify each input data sample of the set of input data samples as OOD data or ID data based on the corresponding input data embedding of the set of input data embeddings, the set of ID text embeddings, and the set of trained OOD text embeddings.

12. The apparatus of claim 1, wherein the input data sample comprises at least one of an image or a video frame.

13. The apparatus of claim 1, further comprising a modem, coupled to one or more antennas, and coupled to one or more processors, wherein the modem and the one or more antennas are configured to receive a representation of the input data sample.

14. The apparatus of claim 1, further comprising one or more microphones configured to capture speech input, wherein:
the one or more processors are configured to convert the speech input to text; and
to obtain the ID text embeddings is based on use of the text as the in-distribution text data.

15. The apparatus of claim 1, wherein the input data sample is acquired from one or more image sensors integrated into one of a vehicle, an extra-reality device, or a mobile device.

16. The apparatus of claim 1, further comprising one or more cameras configured to capture one or more images containing at least one of text, video objects, or combinations thereof, wherein the input data sample is derived from the one or more images.

17. The apparatus of claim 1, further comprising one or more microphones configured to capture speech input, wherein:
the one or more processors are configured to convert the speech input to text; and
the input data sample is based on the text.

18. A method for detecting out-of-distribution (OOD) data, comprising:
processing an input data sample using a trained model to generate an input data embedding;
obtaining a set of in-distribution (ID) text embeddings based on in-distribution text data representative of expected input to the trained model;
obtaining a set of trained OOD text embeddings based on out-of-distribution text data representative of unexpected input to the trained model;
classifying the input data sample as OOD data or ID data based on the input data embedding, the set of ID text embeddings, and the set of trained OOD text embeddings; and
outputting an indication of whether the input data is classified as OOD data or ID data based on the classification.

19. The method according to claim 18, wherein classifying the input data sample as OOD data or ID data comprises:
generating a set of ID probability scores based on the input data embedding and each ID text embedding in the set of ID text embeddings;
generating a set of OOD probability scores based on the input data embedding and each trained OOD text embedding in the set of trained OOD text embeddings; and
combining the set of ID probability scores and the set of OOD probability scores to generate an overall OOD probability score.

20. A non-transitory computer-readable medium comprising instructions, which when executed by one or more processors, cause the one or more processors to perform operations for detecting out-of-distribution (OOD) data, comprising:
processing an input data sample using a trained model to generate an input data embedding;
obtaining a set of in-distribution (ID) text embeddings based on in-distribution text data representative of expected input to the trained model;
obtaining a set of trained OOD text embeddings based on out-of-distribution text data representative of unexpected input to the trained model;
classifying the input data sample as OOD data or ID data based on the input data embedding, the set of ID text embeddings, and the set of trained OOD text embeddings; and
outputting an indication of whether the input data is classified as OOD data or ID data based on the classification.
